(19) United States
(12) Patent Application Publication
(10) Pub. No.: US 2026/0146831 A1
(43) Pub. Date: May 28, 2026

(54) INTRUDER DETERRENT APPARATUS

(71) Applicant: Charlie Washington, Orland Park, IL (US)

(72) Inventor: Charlie Washington, Orland Park, IL (US)

(21) Appl. No.: 18/962,947

(22) Filed: Nov. 27, 2024

(51) Int. Cl. F41H 9/00; A47J 42/36

(52) U.S. Cl. CPC F41H 9/00; A47J 42/36

(57) ABSTRACT

An intruder deterrent apparatus for deterring potential intruders from illicitly entering a premises includes a housing which houses a container filled with peppercorns. A grinding mechanism is mounted in the housing and is operable to grind the peppercorns into fine particulates small enough to move through apertures in the container. A fan is mounted in the housing and is operable to cause air to flow through the housing which urges the particulates of the peppercorns out of the housing. When positioned advantageously, such as directing an outlet of the housing near where an individual would be when attempting to enter a premises, the apparatus may be used to launch the peppercorn particulates into the face of the individual. The individual may then be incapacitated or caused enough discomfort that he or she abandons the attempt to enter the premises.

### (B) CROSS-REFERENCE TO RELATED APPLICATIONS

Not Applicable

### (C) STATEMENT REGARDING FEDERALLY SPONSORED RESEARCH OR DEVELOPMENT

Not Applicable

### (D) THE NAMES OF THE PARTIES TO A JOINT RESEARCH AGREEMENT

Not Applicable

### (E) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (F) STATEMENT REGARDING PRIOR DISCLOSURES BY THE INVENTOR OR JOINT INVENTOR

Not Applicable

### (G) BACKGROUND OF THE INVENTION

### (1) Field of the Invention

The disclosure relates to deterrent apparatuses and more particularly pertains to a new deterrent apparatus for deterring potential intruders from illicitly entering a premises.

### (2) Description of Related Art Including Information Disclosed Under 37 CFR 1.97 and 1.98.

The prior art describes various deterrent apparatus which release an irritant into the atmosphere in order to incapacitate or cause discomfort to a potential intruder or potential attacker. However, the prior art fails to describe such a device that comprises a grinding mechanism for grinding peppercorns and a fan for blowing the peppercorns toward a potential intruder's face.

### (H) BRIEF SUMMARY OF THE INVENTION

An embodiment of the disclosure meets the needs presented above by generally comprising a housing which defines an interior space in the housing. The housing also defines an inlet and an outlet which extend into the interior space of the housing. A container is mounted in the housing. The container comprises a bottom wall and a perimeter wall, and the perimeter wall is coupled to and extending away from the bottom wall. The container defines an interior volume surrounded by the bottom wall and the perimeter wall. The bottom wall defines a plurality of apertures which extends through the bottom wall. A plurality of peppercorns is positioned in the interior volume of the container. A grinding mechanism is mounted in the housing and is operable to grind the plurality of peppercorns. The grinding mechanism comprises and an engagement member and an actuator. The actuator is operable to move the engagement member against the plurality of peppercorns to produce particulates of the peppercorns. A processor is mounted in the housing and is operatively coupled to the grinding mechanism. A fan is mounted in the housing and is operably coupled to the processor. The fan is positioned and configured to urge air into the housing through the inlet and out of the housing through the outlet when activated.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (I) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of an intruder deterrent apparatus according to an embodiment of the disclosure.

FIG. 2 is a side view of an embodiment of the disclosure.

FIG. 3 is a top view of an embodiment of the disclosure.

FIG. 4 is a bottom view of an embodiment of the disclosure.

FIG. 5 is an in-use view of an embodiment of the disclosure.

### (J) DETAILED DESCRIPTION OF THE INVENTION

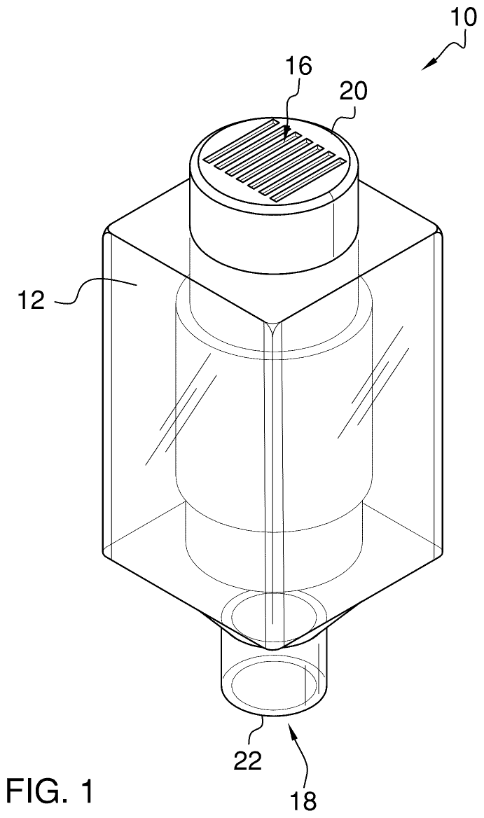

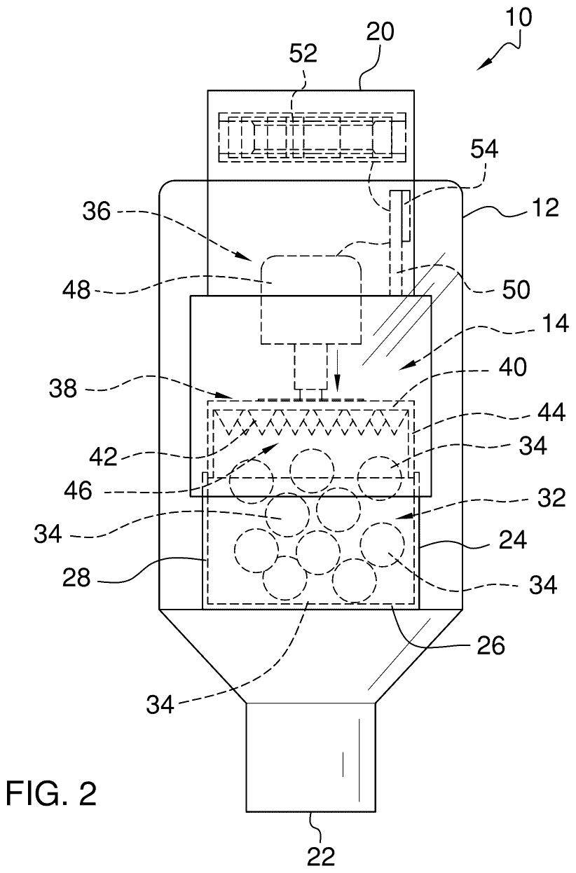

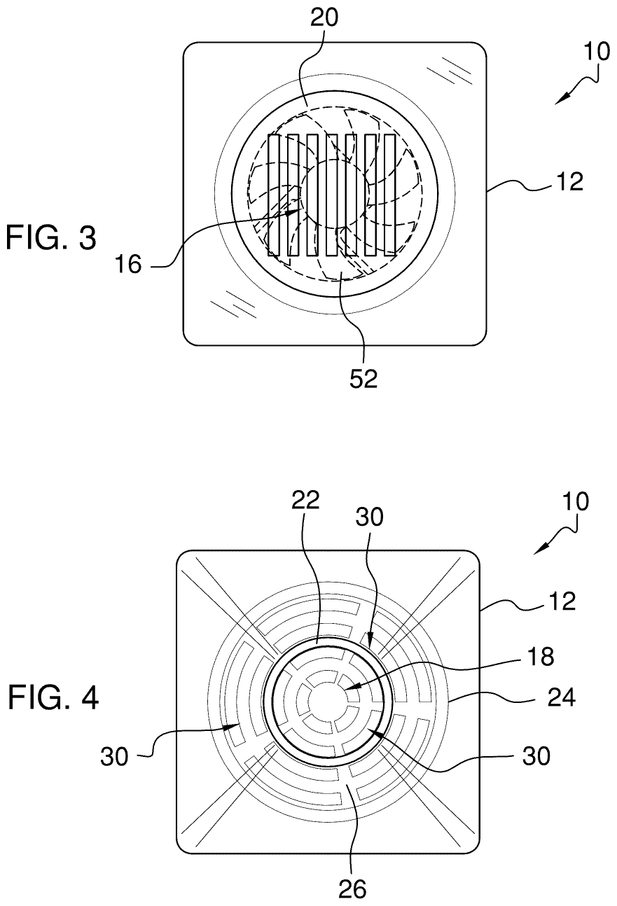

With reference now to the drawings, and in particular to FIGS. 1 through 5 thereof, a new deterrent apparatus embodying the principles and concepts of an embodiment of the disclosure and generally designated by the reference numeral 10 will be described.

As best illustrated in FIGS. 1 through 5, the intruder deterrent apparatus 10 generally comprises a housing 12 which defines an interior space 14 therein. The housing 12 also defines an inlet 16 and an outlet 18 which extend into the interior space 14 of the housing 12. The outlet 18 is positioned at a bottom end 22 of the housing 12, and the inlet 16 is positioned at a top end 20 of the housing 12. A container 24 is mounted in the housing 12. The container 24 comprises a bottom wall 26 and a perimeter wall 28, wherein the perimeter wall 28 is coupled to and extends away from the bottom wall 26. The container 24 defines an interior volume 32 which is surrounded by the bottom wall 26 and the perimeter wall 28. The bottom wall 26 defines a plurality of apertures 30 which extends through the bottom wall 26. A plurality of peppercorns 34 is positioned in the interior volume 32 of the container 24.

A grinding mechanism 36 is mounted in the housing 12 and is operable to grind the plurality of peppercorns 34. The grinding mechanism 36 comprises an engagement member 38 and an actuator 48. The actuator 48 is a linear actuator which moves the engagement member 38 alternately toward and away from the bottom wall 26 of the container 24. When the actuator 48 is operated to urge the engagement member 38 toward the bottom wall 26 of the container 24, the engagement member 38 engages the peppercorns 34 and grinds the peppercorns 34 to form particulates 35 of the peppercorns 34 small enough to be moved through at least one of the apertures 30 in the bottom wall 26 of the container 24. In other embodiments, the actuator 48 may comprise a motor which rotates the engagement member 38 in an abrading fashion against the peppercorns 34. The actuator 48 also may comprise linkages, drivetrains, or the like such that the engagement member 38 is movable against the peppercorns 34 to grind the peppercorns 34. Other suitable actuating means may be used for the actuator 48 such as pneumatic actuators, solenoids, or the like.

The engagement member 38 comprises a base panel 40, a peripheral wall 44, and a plurality of teeth 46. The peripheral wall 44 and the teeth 46 are coupled to a lower face 42 of the base panel 40. The peripheral wall 44 surrounds the plurality of teeth 46 and is complementary in shape to the perimeter wall 28 of the container 24. The engagement member 38 is sized and positioned to slide within the perimeter wall 28 of the container 24.

A processor 50 is mounted in the housing 12 and is operatively coupled to the grinding mechanism 36. A fan 52 is mounted in the housing 12 and is operably coupled to the processor 50. The fan 52 is positioned and configured to urge air into the housing 12 through the inlet 16 and out of the housing 12 through the outlet 18 when activated.

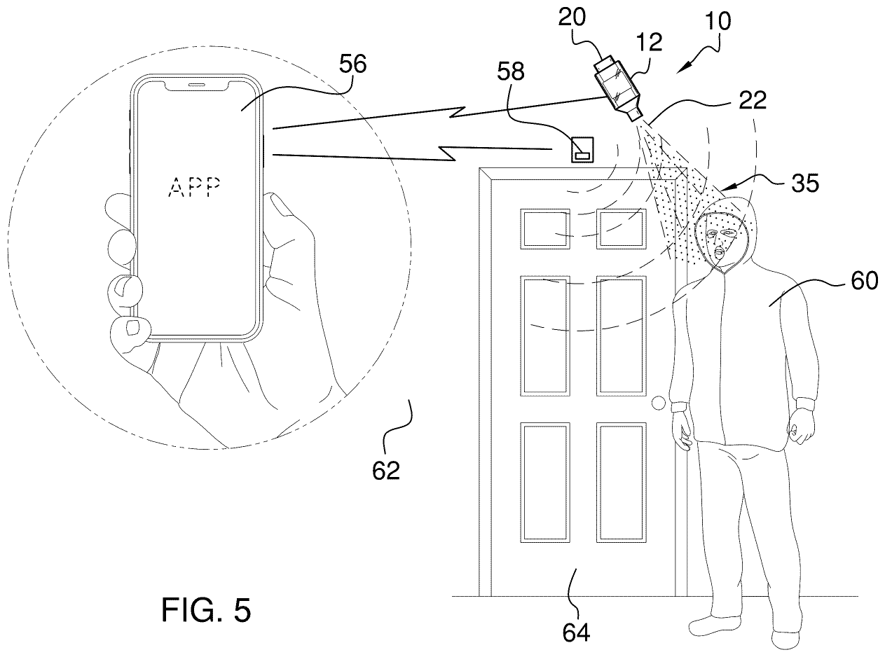

A transceiver 54 is mounted in the housing 12 and is operatively coupled to the processor 50. A remote electronic device 56 is in wireless communication with the processor 50 via the transceiver 54 and is operable to transmit command signals to the processor 50. A sensor 58 is in wireless communication with the remote electronic device 56 and is configured to detect an individual 60 located proximate to the outlet 18 of the housing 12. The sensor 58 may comprise a motion detector, a proximity detector, a thermal detector, or any other suitable sensor for detecting the individual 60. As seen in FIG. 5, the housing 12 of the intruder deterrent apparatus 10 and the sensor 58 may be separately mounted to a wall 62 near an entry point to a dwelling or another area such as a door 64, a window, or the like, to which intruders may attempt to illicitly gain entry. In other embodiments, the sensor 58 may be mounted to the housing 12.

The remote electronic device 56 may be a smartphone, a tablet, a personal computer, or another suitable device for receiving input from a user and transmitting commands to the processor 50 via the transceiver 54. The remote electronic device 56 may include an application which directs the remote electronic device 56 to receive signals from the sensor 58 indicative of the presence of the individual 60 and notify the user via visual, audio, haptic, or other suitable notifications. The remote electronic device 56, via the application, may then be operated to receive input from the user directing the processor 50 to cause the grinding mechanism 36 to grind the peppercorns 34 and activate the fan 52. In some embodiments, the sensor 58 may directly signal the processor 50 to activate the grinding mechanism 36 and the fan 52.

In use, when the grinding mechanism 36 and the fan 52 are activated, the grinding mechanism 36 grinds the peppercorns 34 and the fan 52 blows the resulting particulates 35 of the peppercorns 34 out of the outlet 18 of the housing 12. The particulates 35 may fall via gravity out of the container 24 through the apertures 30 of the bottom wall 26 into an air stream the fan 52 generates that flows around the container 24. Or, in some embodiments, air may flow through the container 24 as well to urge the particulates 35 through the apertures 30 of the bottom wall 26 of the container 24 via the air flow. In such cases, the container 24 or the engagement member 38 may have openings to facilitate air flowing into the container 24 before flowing out through the apertures 30 in the bottom wall 26 of the container 24. The particulates 35 of the peppercorns 34 may be launched via operation of the intruder deterrent apparatus 10 into a face of the individual 60 in order to irritate the individual's 60 eyes or other sensitive areas and cause enough discomfort to the individual 60 that the individual 60 abandons any attempt to intrude upon the premises.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An intruder deterrent apparatus comprising:
a housing, the housing defining an interior space in the housing, the housing defining an inlet and an outlet which extend into the interior space of the housing;
a container mounted in the housing, the container comprising a bottom wall and a perimeter wall, the perimeter wall being coupled to and extending away from the bottom wall, the container defining an interior volume surrounded by the bottom wall and the perimeter wall, the bottom wall defining a plurality of apertures which extends through the bottom wall;
a plurality of peppercorns positioned in the interior volume of the container;
a grinding mechanism mounted in the housing, the grinding mechanism being operable to grind the plurality of peppercorns, the grinding mechanism comprising:
an engagement member, the engagement member being movable against the plurality of peppercorns; and
an actuator, the actuator being operable to move the engagement member against the plurality of peppercorns; and
a processor mounted in the housing and operatively coupled to the grinding mechanism; and
a fan mounted in the housing, the fan being operably coupled to the processor, the fan being positioned and configured to urge air into the housing through the inlet and out of the housing through the outlet when activated.

2. The intruder deterrent apparatus of claim 1, wherein the outlet of the housing is positioned at a bottom end of the housing.

3. The intruder deterrent apparatus of claim 2, wherein the inlet of the housing is positioned at a top end of the housing.

4. The intruder deterrent apparatus of claim 1, wherein the engagement member of the grinding mechanism is movable alternately toward and away from the bottom wall of the container, the actuator of the grinding mechanism comprising a linear actuator.

5. The intruder deterrent apparatus of claim 1, wherein the engagement member of the grinding mechanism comprises a base panel and a plurality of teeth, the plurality of teeth being coupled to a lower face of the base panel.

6. The intruder deterrent apparatus of claim 5, wherein the engagement member further comprises a peripheral wall which is coupled to the base panel, the peripheral wall surrounding the plurality of teeth, the peripheral wall being surrounded by the perimeter wall of the container, the peripheral wall being complementary in shape to the perimeter wall of the container.

7. The intruder deterrent apparatus of claim 1, further comprising:
a transceiver operatively coupled to the processor; and
a remote electronic device in wireless communication with the processor via the transceiver, the remote electronic device being operable to transmit command signals to the processor.

8. The intruder deterrent apparatus of claim 7, further comprising a sensor in wireless communication with the remote electronic device, the sensor being configured to detect an individual located proximate to the outlet of the housing.

9. An intruder deterrent apparatus comprising:
a housing, the housing defining an interior space in the housing, the housing defining an inlet and an outlet which extend into the interior space of the housing, the outlet being positioned at a bottom end of the housing, the inlet being positioned at a top end of the housing;
a container mounted in the housing, the container comprising a bottom wall and a perimeter wall, the perimeter wall being coupled to and extending away from the bottom wall, the container defining an interior volume surrounded by the bottom wall and the perimeter wall, the bottom wall defining a plurality of apertures which extends through the bottom wall;
a plurality of peppercorns positioned in the interior volume of the container;
a grinding mechanism mounted in the housing, the grinding mechanism being operable to grind the plurality of peppercorns, the grinding mechanism comprising:
an engagement member, the engagement member being movable against the plurality of peppercorns, the engagement member being movable alternately toward and away from the bottom wall of the container, the engagement member comprising a base panel and a plurality of teeth, the plurality of teeth being coupled to a lower face of the base panel, the engagement member further comprising a peripheral wall which is coupled to the bottom wall, the peripheral wall surrounding the plurality of teeth, the peripheral wall being surrounded by the perimeter wall of the container, the peripheral wall being complementary in shape to the perimeter wall of the container; and
an actuator, the actuator being operable to move the engagement member against the plurality of peppercorns, the actuator comprising a linear actuator;
a processor mounted in the housing and operatively coupled to the grinding mechanism;
a fan mounted in the housing, the fan being operably coupled to the processor, the fan being positioned and configured to urge air into the housing through the inlet and out of the housing through the outlet when activated;
a transceiver mounted in the housing, the transceiver being operatively coupled to the processor;
a remote electronic device in wireless communication with the processor via the transceiver, the remote electronic device being operable to transmit command signals to the processor; and
a sensor in wireless communication with the remote electronic device, the sensor being configured to detect an individual located proximate to the outlet of the housing.
